(19) United States
(12) Patent Application Publication
(10) Pub. No.: US 2020/0342897 A1
(43) Pub. Date: Oct. 29, 2020

(54) METHOD, SYSTEM, AND PROGRAM FOR DETECTING SNORING

(71) Applicant: MAETEL CO., LTD., Seoul (KR)

(72) Inventors: Key JEONG, Suwon-si (KR); Seung Yo KIM, Seoul (KR); Woo June CHOI, Incheon (KR); Je Hui LEE, Incheon (KR)

(73) Assignee: MAETEL CO., LTD., Seoul (KR)

(21) Appl. No.: 16/923,664

(22) Filed: Jul. 8, 2020

Related U.S. Application Data
(63) Continuation of application No. PCT/KR2018/012568, filed on Oct. 24, 2018.

(30) Foreign Application Priority Data
Jan. 9, 2018 (KR) 10-2018-0002691

(51) Int. Cl. G10L 25/66; G10L 25/27

(52) U.S. Cl. CPC G10L 25/66; G10L 25/27

(57) ABSTRACT

The present invention provides a method, a system, and a program for detecting snoring through a sleeper's sound. A method for detecting snoring according to the present invention comprises the steps of: collecting a sound; charging or discharging a capacitor due to the collected sound; detecting a variance of a capacitance of the capacitor; and determining whether a sleeper snores, on the basis of a result of the detection.

### CROSS-REFERENCE TO RELATED APPLICATIONS

The present application is a continuation of International Patent Application No. PCT/KR2018/012568, filed on Oct. 24, 2018 which is based upon and claims the benefit of priority to Korean Patent Application No. 10-2018-0002691 filed on Jan. 9, 2018. The disclosures of the above-listed applications are hereby incorporated by reference herein in their entirety.

### BACKGROUND

Embodiments of the inventive concept described herein relate to a method for detecting snoring, a system therefor, and a program therefor, and more particularly, relate to a method for detecting snoring using a sound of a sleeper, a system therefor, and a program therefor.

In general, persons having sleep disorders have two or more disorders such as insomnia, respiratory disorders during sleep, hypnolepsy, and anxietas tibiarum. Due to this, the persons have medical, neurological, and psychiatric diseases, which are exacerbated, while leading their normal lives. The disorders may lead to serious illness such as cardiac infarction or stroke.

Sleep is rapid eye movement (REM) sleep and non-rapid eye movement (Non-REM) sleep and repeats at intervals of 90 to 120 minutes to generally have intervals of 4 to 6 times a night. Because oxygen is correctly supplied to the brains of persons who sleep snoring all night, they complain of a headache when getting up in the morning. Because the persons do not recover from tiredness overnight due to the broken sleep pattern, they get a lot of sleep during the day. To improve this, persons use an instrument, such as a breathing induction band, a snoring clip, or an anti-mouth band, or a snoring spray and undergo a snoring operation. However, this is expensive in cost to burden persons. Because there is a possibility of recurrence, people hesitate. Furthermore, the method using the instrument is temporary. Persons complain about inconvenience during sleep and often give up performing the method.

To prevent such snoring, pillows capable of waking sleepers by moving when they snore during sleep are proposed. However, because such pillows wake sleepers by moving when sounds are detected from the sleepers, they wake sleepers in a situation where the sleepers do not snore.

A technology serving as the background of the inventive concept is disclosed in Korean Patent Application Laying-open No. 10-2016-0125840 or the like, but, it does not propose a fundamental solution to the above-mentioned problems.

### SUMMARY

Embodiments of the inventive concept provide a method for detecting snoring to detect a variance in the capacitance of a capacitor charged or discharged by a sound of a sleeper and determine whether the sleeper snores, a system therefor, and a program therefor.

The technical problems to be solved by the inventive concept are not limited to the aforementioned problems, and any other technical problems not mentioned herein will be clearly understood from the following description by those skilled in the art to which the present disclosure pertains.

According to an exemplary embodiment, a method for detecting snoring may include charging or discharging a capacitor using a sound collected from a sleeper, detecting, by a computer, a variance in capacitance of the capacitor, and determining, by the computer, whether the sleeper snores depending on the determined result.

Furthermore, the method may further include receiving, by the computer, information about breathing of the sleeper, the information being collected from the sleeper and analyzing, by the computer, a breathing pattern of the sleeper using the information about the breathing. The converting may include determining, by the computer, that the sleeper is snoring, when the result of detecting the variance in the capacitance and the result of analyzing the breathing pattern are determined as snoring.

Furthermore, the detecting may include calculating an increment in capacitance per unit time and determining whether the increment is indicated as being greater than or equal to a first reference value at a predetermined period.

Furthermore, the detecting may include calculating an increment in the capacitance per unit time, calculating a second reference value using increments in the capacitance during a predetermined time and determining whether the increment is indicated as being greater than or equal to the second reference value at a predetermined period.

Furthermore, the second reference device may be calculated by multiplying a value obtained by dividing the sum of the increments during the predetermined time by an increased number of times by a constant.

Furthermore, the detecting may include calculating the increment in capacitance per unit time and calculating the increment as “0”, when the increment is less than or equal to “0”.

Furthermore, the method may further include increasing the volume of air in two air pockets of a pillow, when it is determined that the sleeper is snoring and decreasing the volume of air in the two air pockets of the pillow, when it is determined that the snoring of the sleeper is ended.

Furthermore, the detecting may include calculating an increment in the capacitance per unit time and detecting whether the increment is indicated as being greater than or equal to a third reference value at a predetermined period. The increasing of the volume of air may include increasing the volume of air in any one of the two air pockets and decreasing the volume of air in the other of the two air pockets.

Furthermore, the increasing of the volume of air may include alternately increasing or decreasing the volume of air in the two air pockets at a predetermined time interval.

Furthermore, the method may further include transmitting a time when the sleeper starts to snore and a time when the sleeper finishes snoring to a terminal of the sleeper.

According to an exemplary embodiment, a system for detecting snoring may include a collection unit that collects a sound, a capacitor charged or discharged by the sound collected by the collection unit, a detection unit that detects a variance in capacitance of the capacitor, and a determination unit that determines whether a sleeper snores as a result of the detection of the detection unit.

Furthermore, the system may further include an atmospheric pressure sensor that collects breathing information of the sleeper. The detection unit may analyze a breathing pattern of the sleeper using the collected breathing information. The determination unit may determine that the sleeper is snoring, when the result of detecting the variance in the capacitance and the result of analyzing the breathing pattern are determined as snoring.

Furthermore, the detection unit may calculate an increment in the capacitance per unit time, may calculate a second reference value using increments in the capacitance during a predetermined time, and may determine whether the increment is indicated as being greater than or equal to a first reference value or the second reference value at a predetermined period.

According to an exemplary embodiment, a program for detecting snoring may be combined with a computer which is hardware and may be stored in a medium to execute the method for detecting the snoring.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating a snoring detection system according to an embodiment of the inventive concept;

FIG. 2 is a flowchart illustrating a method for detecting snoring according to an embodiment of the inventive concept;

FIG. 3 is a flowchart illustrating a method for detecting snoring and controlling an air pocket of a pillow according to another embodiment of the inventive concept;

FIGS. 4, 5, and 6 are drawings illustrating a pattern of a general sound according to an embodiment of the inventive concept;

FIG. 7 is a drawing illustrating a pattern of a snore according to an embodiment of the inventive concept;

FIGS. 8, 9, and 10 are drawings illustrating an example of calculating a second reference value by means of a pattern of a general sound according to an embodiment of the inventive concept;

FIGS. 11 and 12 are drawings illustrating an example of calculating a second reference value by means of a pattern of a snore according to an embodiment of the inventive concept;

FIGS. 13A and 13B are drawings illustrating an example of detecting snoring and controlling an air pocket of a pillow according to another embodiment of the inventive concept;

FIG. 14 is a drawing illustrating an example of determining sleeper's snoring by means of a snore and a breathing pattern according to an embodiment of the inventive concept; and

FIG. 15 is a flowchart illustrating a method for determining sleeper's snoring by means of a snore and a breathing pattern according to an embodiment of the inventive concept.

### DETAILED DESCRIPTION

Advantages, features, and methods of accomplishing the same will become apparent with reference to embodiments described in detail below together with the accompanying drawings. However, the inventive concept is not limited by embodiments disclosed hereinafter, and may be implemented in various forms. Rather, these embodiments are provided to so that this disclosure will be through and complete and will fully convey the concept of the invention to those skilled in the art, and the inventive concept will only be defined by the appended claims.

Terms used in the specification are used to describe embodiments of the inventive concept and are not intended to limit the scope of the inventive concept. In the specification, the terms of a singular form may include plural forms unless otherwise specified. The expressions “comprise” and/or “comprising” used herein indicate existence of one or more other elements other than stated elements but do not exclude presence of additional elements. Like reference numerals designate like elements throughout the specification, and the term “and/or” may include each of stated elements and one or more combinations of the stated elements. The terms such as “first” and “second” are used to describe various elements, but it is obvious that such elements are not restricted to the above terms. The above terms are used only to distinguish one element from the other. Thus, it is obvious that a first element described hereinafter may be a second element within the technical scope of the inventive concept.

Unless otherwise defined herein, all terms (including technical and scientific terms) used in the specification may have the same meaning that is generally understood by a person skilled in the art. Also, terms which are defined in a dictionary and commonly used should be interpreted as not in an idealized or overly formal detect unless expressly so defined.

Hereinafter, an embodiment of the inventive concept will be described in detail with reference to the accompanying drawings.

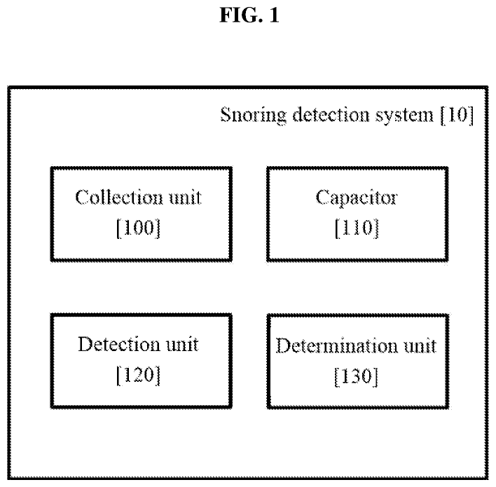

FIG. 1 is a block diagram illustrating a snoring detection system 10 according to an embodiment of the inventive concept.

A description will be given of the snoring detection system 10 according to an embodiment of the inventive concept with reference to FIG. 1.

The snoring detection system 10 according to an embodiment of the inventive concept may include a collection unit 100, a capacitor 110, a detection unit 120, and a determination unit 130.

The collection unit 100 may collect a sound of a sleeper. Preferably, the collection unit 100 may include a sound collection means such as a microphone to collect a sound generated from a sleeper, may be worn on a sleeper's body to accurately collect a sound generated from the sleeper, may be provided in a pillow used by the sleeper, and may be located around the sleeper using a separate device to collect a sound generated from the sleeper.

The capacitor 110 may refer to a generally used capacitor and may be charged or discharged by the sound of the sleeper, which is collected by the collection unit 100.

In this case, the collection unit 100, the capacitor 110, the detection unit 120, and the determination unit 130 may be composed in one module to operate by collecting a sound at a short distance from the sleeper.

Furthermore, the snoring detection system 10 may further include a measurement unit for measuring a capacitance of the capacitor 110. The collection unit 100, the capacitor 110, and the measurement unit may be composed in one module to collect a sound near a sleeper such that the capacitor 110 is charged or discharged. The measurement unit may measure a capacitance of the capacitor 110 and may transmit the measured data to a terminal of the sleeper. The detection unit 120 and the determination unit 130 of the terminal may detect and determine whether the sleeper snores.

Furthermore, only the collection unit 100 capable of performing communication may be composed as a separate module to be located near the sleeper. A computer may receive sound data from the collection unit 100 and the capacitor 110 may be charged or discharged by the received sound data. The detection unit 120 of the computer may detect a capacitance of the capacitor 110, and the determination unit 130 of the computer may determine whether the sleeper snores.

In this case, the terminal refers to a computer having a communication means such as a smartphone, a tablet, or a notebook.

The detection unit 120 may detect a variance in the capacitance of the capacitor 110. In detail, the detection unit 120 may check and calculate whether a capacitance of the capacitor 110 is charged or discharged by the sound of the sleeper, which is collected via the collection unit 100, such that the determination unit 130 may determine whether the sleeper snores.

The determination unit 130 may determine whether the sleeper snores as a result of the detection of the detection unit 120.

As an example, the detection unit 120 may calculate an increment in the capacitance per unit time and may detect whether the calculated increment is indicated as being greater than or equal to a first reference value at a predetermined period. The detection unit 120 may detect whether the calculated increment is indicated as being greater than or equal to the first reference value at the predetermined period, and the determination unit 130 may determine whether the sleeper snores as a result of the detection.

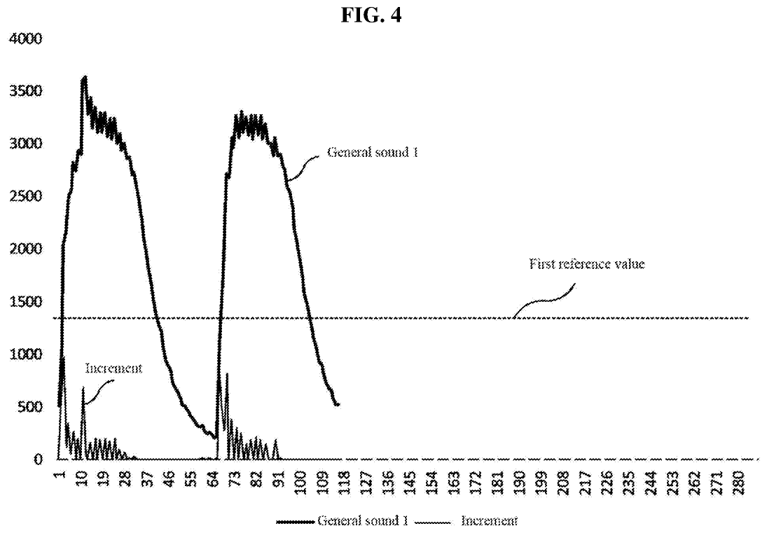

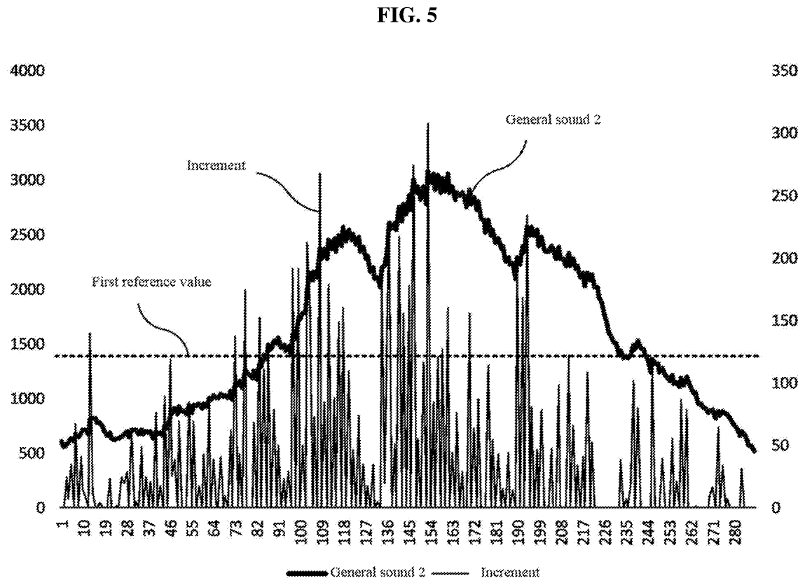

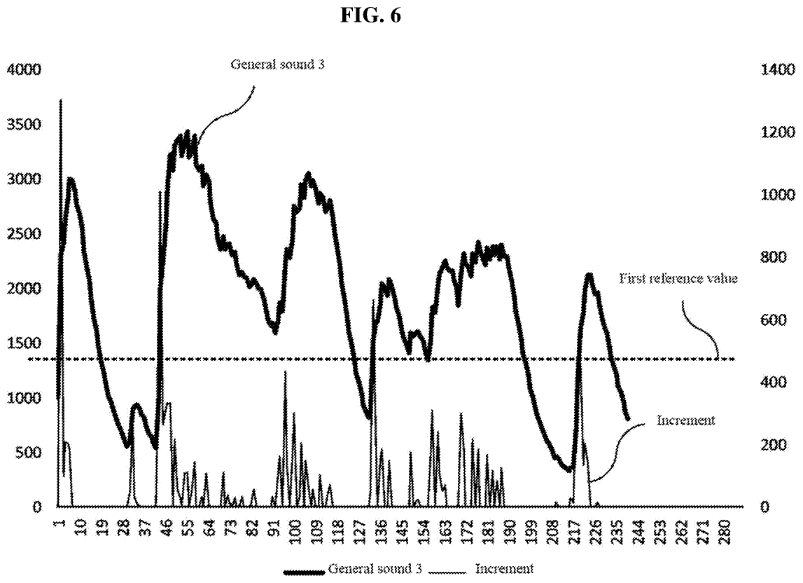

A detailed description and an example thereof will be described with reference to FIGS. 4 to 7.

As another example, the detection unit 120 may calculate an increment in the capacitance of the capacitor 110 per unit time, may calculate a second reference value using increments in the capacitance during a predetermined time, and may detect whether the increment is indicated as being greater than or equal to the second reference value at the predetermined period. The detection unit 120 may detect whether the calculated increment is indicated as being greater than or equal to the second reference value at the predetermined period, and the determination unit 130 may determine whether the sleeper snores as a result of the detection.

Furthermore, in this case, the second reference value may be calculated by multiplying a value obtained by dividing the sum of the increments during the predetermined time by an increased number of times by a constant.

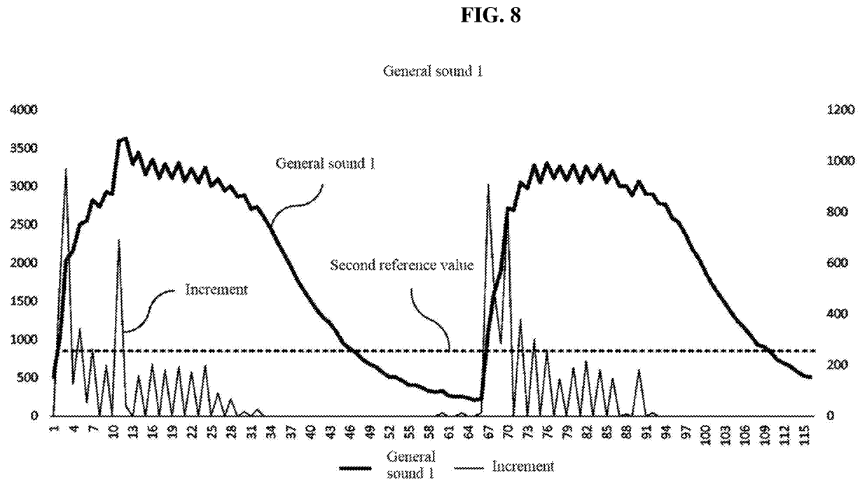

A detailed description and an example thereof will be described with reference to FIGS. 8 to 12.

Furthermore, the detection unit 120 may calculate an increment in capacitance per unit time and may calculate the increment as “0” when the increment is less than or equal to “0”. For example, when a sound is generated from a sleeper, capacitance may be increased. As a sound of the sleeper is reduced or removed, a capacitance of the capacitor 110 may be reduced and the detection unit 120 may recognize it as a minus. Because there is no minus in a sound actually generated from the sleeper and because the sound is reduced or removed, as described above, when the increment is less than or equal to “0”, the detection unit 120 may calculate the increment as “0” such that a mechanical error does not occur.

Furthermore, the determination unit 130 may transmit a time when the sleeper starts to snore and a time when the sleeper finishes snoring to the terminal of the sleeper. Due to this, the sleeper may identify data using the terminal after sleep and may determine how much the snoring occurs during sleep.

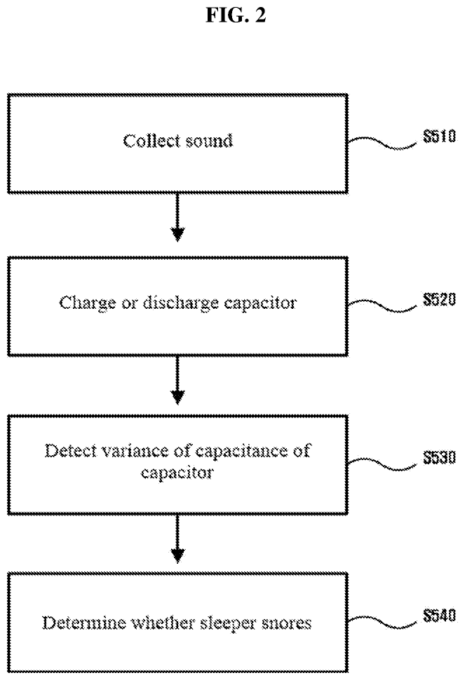

FIG. 2 is a flowchart illustrating a method for detecting snoring according to an embodiment of the inventive concept.

A description will be given of the method for detecting the snoring according to an embodiment of the inventive concept with reference to FIG. 2.

First of all, in operation S510, a sound generated from a sleeper may be collected.

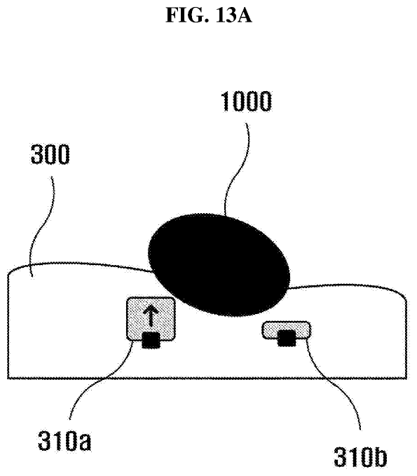

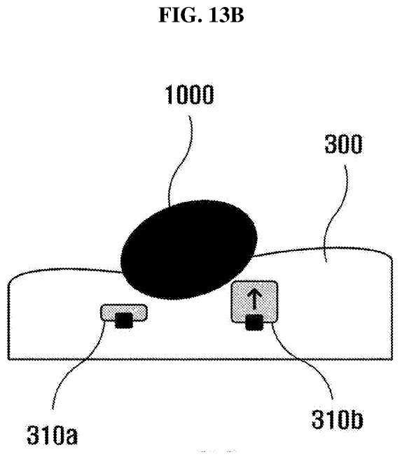

In detail, the sound generated from the sleeper may be collected by means of a sound collection means, such as a microphone, which is provided in a pillow 300 of FIGS. 13A and 13B or near the pillow 300.

In operation 520, a capacitor 110 of FIG. 1 may be charged or discharged by the sound collected in operation S510.

This means that as the capacitor 110 is charged or discharged by the sound collected from the sleeper, its capacitance is changed.

In operation 530, a variance in the capacitance of the capacitor 110 may be detected.

A detection unit 120 of a computer may calculate and detect a variance in capacitance depending on a predetermined detection condition.

In detail, the detecting of the variance in the capacitance of the capacitor 110 may include calculating an increment in the capacitance per unit time and detecting whether the calculated increment per unit time is indicated as being greater than or equal to a first reference value at a predetermined period.

Furthermore, the detecting of the variance in the capacitance of the capacitor 110 may include calculating an increment in the capacitance per unit time, calculating a second reference value using increments in the capacitance during a predetermined time, and detecting whether the calculated increment per unit time is indicated as being greater than or equal to the second reference value at the predetermined period. In this case, the second reference value may be calculated by multiplying a value obtained by dividing the sum of the increments during the predetermined time by an increased number of times by a constant.

In operation S540, a determination unit 130 of the computer may determine whether the sleeper snores.

In detail, when a condition is met as a result of the detection of the detection unit 120 depending on the detection condition, the determination unit 130 may determine that the sleeper snores. When the condition is not met, the determination unit 130 may determine that the sleeper is not snoring.

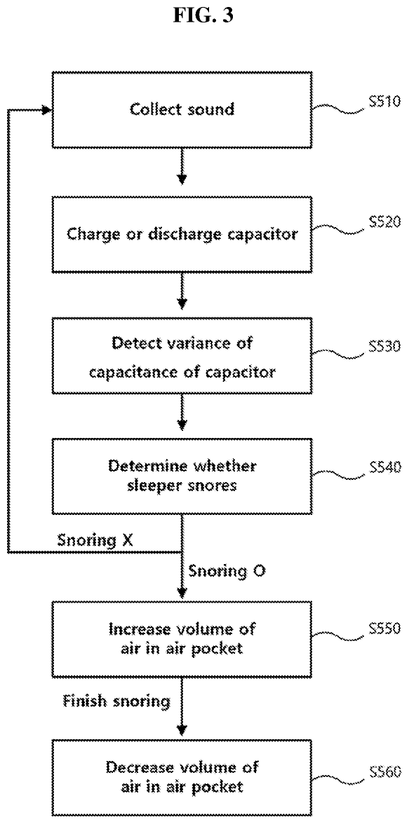

FIG. 3 is a flowchart illustrating a method for detecting snoring and controlling an air pocket of a pillow according to another embodiment of the inventive concept.

In FIG. 3, an embodiment is exemplified as an operation of changing the volume of air in air pockets 310a and 310b of a pillow 300, when it is determined that the sleeper is snoring after operation S540, such that the sleeper stops snoring.

After operation S540, in operation S550, when it is determined that the sleeper snores, the volume of air of the air pockets 310a and 310b may be increased.

When a determination unit 130 of a computer determines that the sleeper is currently snoring in operation S540, a controller may increase the volume of air in the air pockets 310a and 310b via an air injection part.

Furthermore, a detection unit 120 of the computer may additionally set a third reference value greater than the first reference value. When the increment in capacitance per unit time, which is calculated by the detection unit 120, is indicated as being greater than or equal to the third reference value at the predetermined period, the controller may increase the volume of air in any one of the two air pockets 310a and 310b and may decrease the volume of air in the other of the two air pockets 310a and 310b. In addition, the controller may alternately increase or decrease the volume of air in the two air pockets 310a and 310b at a predetermine time interval.

In S560, when the determination unit 130 determines that the sleeper finishes snoring, the controller may decrease the volume of air in the air pockets 310a and 310b through the air injection part.

Furthermore, the method for detecting the snoring and controlling the air pocket of the pillow may further include transmitting a time when the sleeper starts to snore and a time when the sleeper finishes snoring to a terminal of the sleeper.

Hereinafter, prior to description of FIGS. 4 to 12, a graph will be described in brief.

Capacitances of a capacitor 110 are indicated in numeric values on each graph by sounds collected via the collection unit 100. Left numeric values on the Y-axis refer to ADC sizes of the MCU, right numeric values on the Y-axis refer to numeric values of the set or calculated reference values (e.g., a first reference value, a second reference value, and the third reference value), and X-axis refers to time. An embodiment of the inventive concept is exemplified as 5 ms (0.005 seconds) per 1.

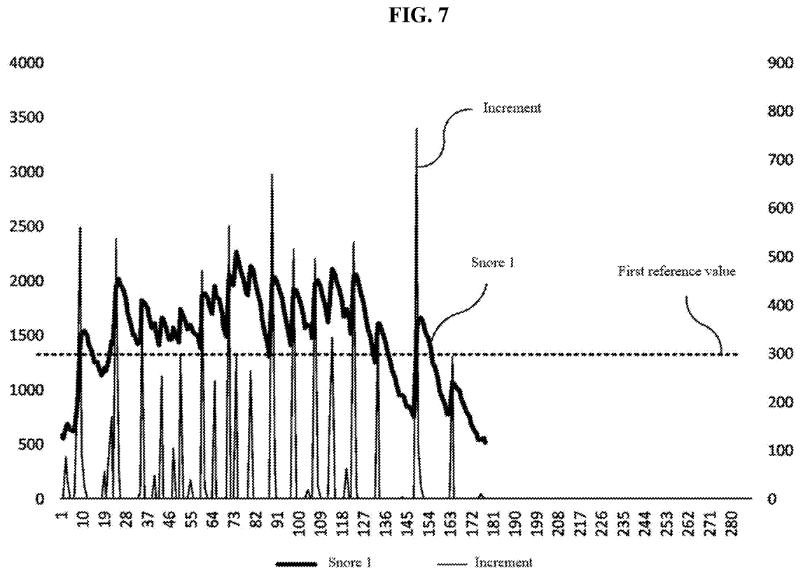

Furthermore, the increment refers to a numeric value increased per unit time. As an example of FIG. 7, an embodiment is exemplified as an increment calculated for every nine units (real time: 0.0045 seconds) on the X-axis.

A general sound refers to making any sound, for example, general sound 1 refers to making the sound “Ah, Ah”, general sound 2 refers to making the sound “uh”, and general sound 3 refers to pronouncing a specific word. The general sound may be similar to a sound capable of being generated during sleep, but may differ from a snore. The general sound is exemplified to help description.

Because a unit and a unit time of the above graph help understanding of the inventive concept, they are not used to mean to limit the technical scope of the inventive concept such that the practicer of the inventive concept easily selects a unit time, a reference value, or the like to suit purposes of the product.

FIGS. 4 to 6 are drawings illustrating a pattern of a general sound according to an embodiment of the inventive concept. FIG. 7 is a drawing illustrating a pattern of a snore according to an embodiment of the inventive concept.

A description will be given of a difference between patterns of a general sound and a snore with reference to FIGS. 4 to 7.

As shown in FIG. 7, it may be seen that a snore increases to an increment similar to that when the sound increases and it may be seen that the increment is indicated within a period of a certain range.

On the other hand, it may be seen that general sounds increase in level to irregular increments and it may be seen that the increment is indicated at an irregular period.

Thus, a detection unit 120 of FIG. 1 may calculate an increment in capacitance per unit time and may detect whether the calculated increment is indicated as being greater than or equal to a first reference value at a predetermined period to determine whether a sleeper snores.

In detail, when the first reference value is set to 1300 and when the range of a period is set every 15 to 25 hours to set being detected consecutively over 4 times as a snoring condition, a determination unit 130 of FIG. 1 may determine that the sleeper is snoring when the calculated increment is detected 4 times over 1300 at intervals of 20 units.

Thus, in detail, the detection unit 120 may calculate an increment in capacitance per unit time and may detect whether the calculated increment is indicated as being greater than or equal to the first reference value over a predetermined number of times within a predetermined period to determine whether a sleeper snores.

When the above condition is matched to general sounds 1 to 3 on the drawings, it may be seen that there is no corresponding item in all the general sounds 1 to 3.

Thus, an embodiment of the inventive concept may more accurately determine whether the sleeper snores based on the measured data, rather than simply detecting snoring after a sound is detected from the sleeper.

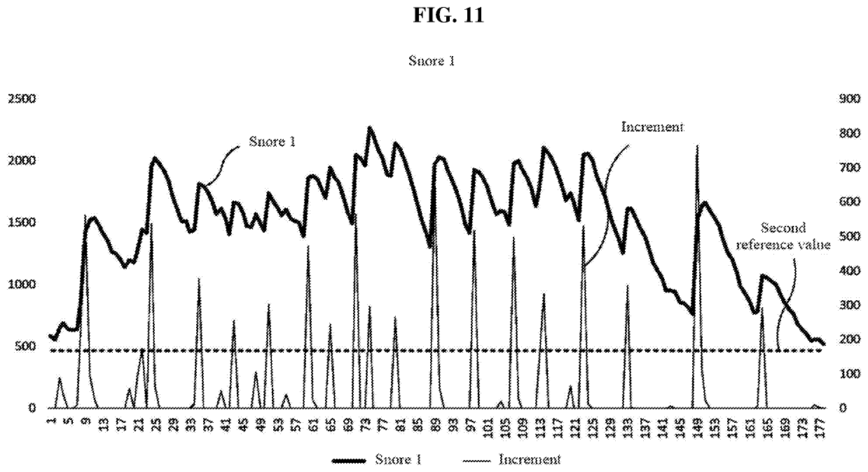

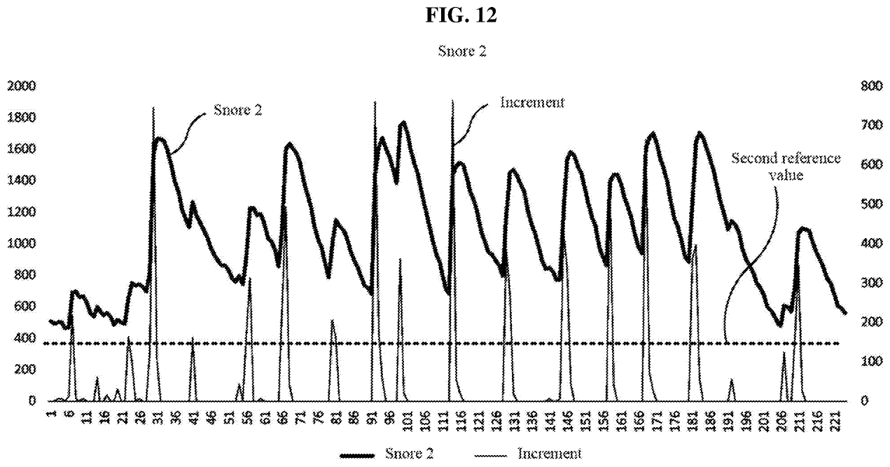

FIGS. 8 to 10 are drawings illustrating an example of calculating a second reference value by means of a pattern of a general sound according to an embodiment of the inventive concept. FIGS. 11 and 12 are drawings illustrating an example of calculating a second reference value by means of a pattern of a snore according to an embodiment of the inventive concept.

Referring to FIGS. 8 to 12, a detection unit 120 of FIG. 1 may calculate an increment in capacitor per unit time, may calculate a second reference value using increments in the capacitance during a predetermined time, and may detect whether the calculated increment is indicated as being greater than or equal to the second reference value at a predetermined period. In this case, the second reference value may be calculated by multiplying a value obtained by dividing the sum of the increments during the predetermined time by an increased number of times by a constant.

$$second reference value = \frac{sum of increased values}{increased number of times} ? , \\ [ A \text{:} constant ] \qquad [ Equation 1 ]$$

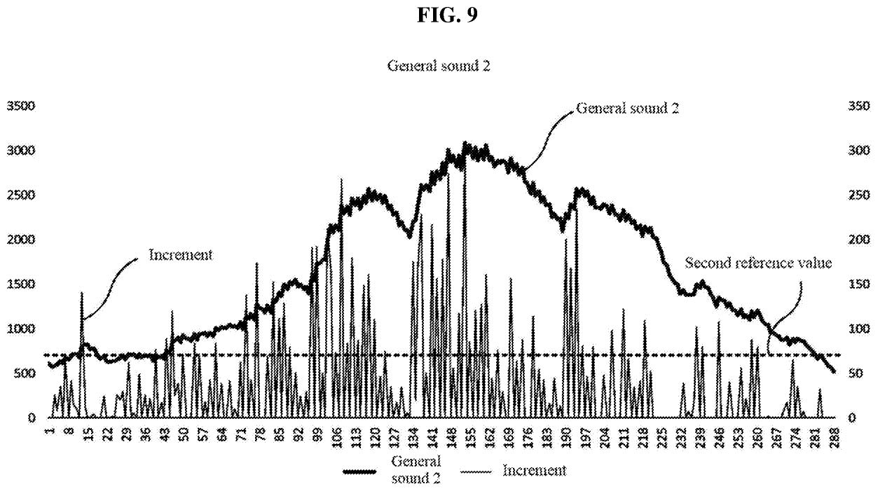

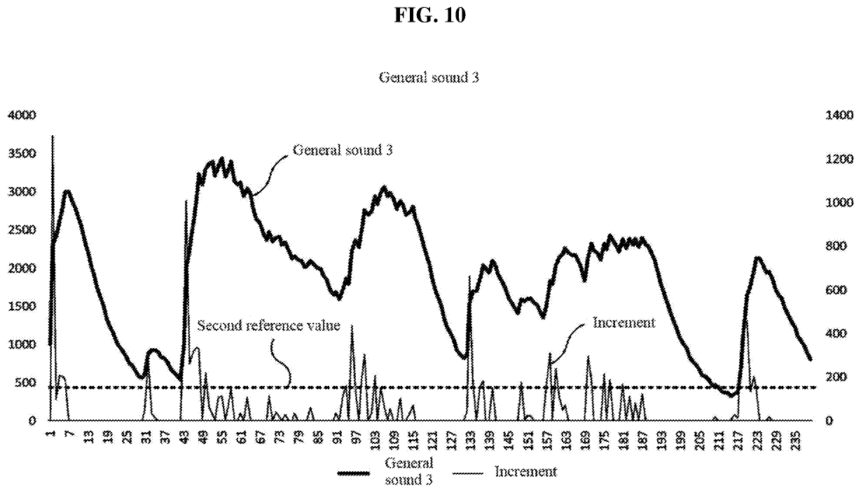

It may be seen that general sound 1 has an increment per unit time, which is infrequently greater than the second reference value, and is concentrated in a front portion where the sound is generated. It may be seen that general sound 2 of FIG. 9 has an increment for unit time, which is frequently greater than the second reference value, and is irregular and it may be seen that increments are irregular in level. It may be seen that general sound 3 of FIG. 10 has an increment per unit time, which is infrequently greater than the second reference value, and is irregular in level.

On the other hand, it may be seen that each of snore 1 and snore 2 has an increment per unit time, which is greater than the second reference value at a certain period and it may be seen that increments are similar in level to each other.

Thus, in detail, the detection unit 120 may calculate an increment in capacitance per unit time and may detect whether the calculated increment is indicated as being greater than or equal to the first reference value over a predetermined number of times within a predetermined period to determine whether a sleeper snores.

Furthermore, the detection unit 120 may calculate an increment in capacitance per unit time, may calculate the second reference value using increments in the capacitance during a predetermined time, and may detect whether the calculated increment is indicated as being greater than or equal to the second reference value over a certain number of times at a predetermined period to determine whether the sleeper snores.

FIGS. 13A and 13B are drawings illustrating an example of detecting snoring and controlling an air pocket of a pillow according to another embodiment of the inventive concept.

Referring to FIGS. 13A and 13B, a snoring detection system 10 according to an embodiment of the inventive concept may be remotely connected with an air injection part provided in a pillow 300.

A detection unit 120 of FIG. 1 may detect a sound of a sleeper using the above-mentioned first reference value or the above-mentioned second reference value, may transmit a signal to the air injection part to increase air in air pockets 310a and 310b when a determination unit 130 of FIG. 1 determines that the sleeper is snoring.

In this case, the detection unit 120 may additionally set a third reference value greater than the first reference value.

Describing it, the detection unit 120 may calculate an increment in capacitance per unit time and may detect whether the calculated increment is indicated as being greater than or equal to the third reference value at a predetermined period to determine whether the sleeper snores. When the determination unit 130 determines that the sleeper is snoring as a result of the detection, the air injection unit may alternately increase or decrease the volume of air in the two air pockets 310a and 310b at a predetermined time interval.

This is a configuration for alternately injecting air into the two air packets 310a and 310b in the pillow 300 and ending the snoring of the sleeper, when the snoring of the sleeper is greater than the first reference value. For example, as shown in FIGS. 13A and 13B, a head 1000 of the sleeper is rolled from side to side according to the volume of air injected into the air pockets 310a and 310b, such that snoring is finished as the direction of the head 1000 is changed.

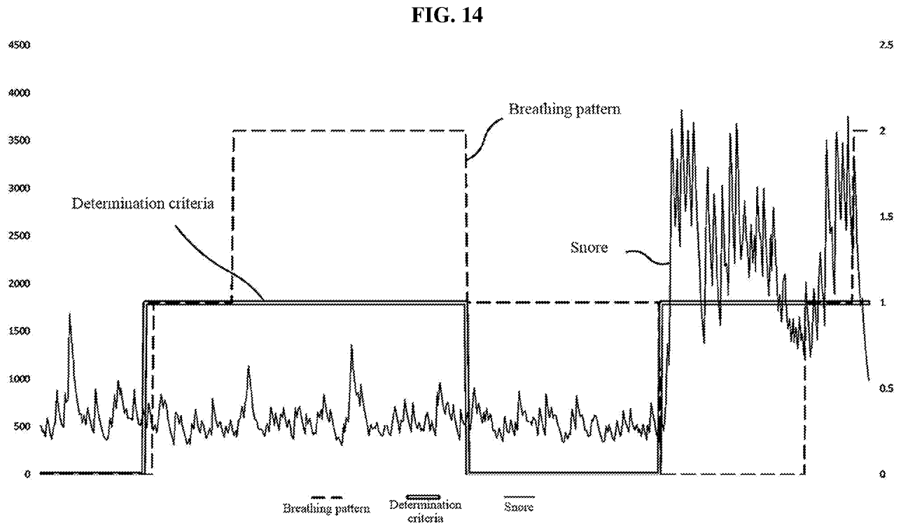

FIG. 14 is a drawing illustrating an example of determining sleeper's snoring by means of a snore and a breathing pattern according to an embodiment of the inventive concept.

A description will be given of an example of determining sleeper's snoring by means of a snore and a breathing pattern according to an embodiment of the inventive concept with reference to FIG. 14.

A snoring detection system 10 of FIG. 1 may further include an atmospheric pressure sensor. The atmospheric pressure sensor may collect breathing information of a sleeper.

A detection unit 120 of FIG. 1 may analyze a breathing pattern of the sleeper using the breathing information collected by the atmospheric pressure sensor. When a determination unit 130 of FIG. 1 determines that the sleeper is snoring when the result of detecting the variance in the capacitance of a capacitor 110 of FIG. 1 and the result of analyzing the breathing pattern are determined as snoring.

For example, when the snore is greater than or equal to a reference value and corresponds to snoring and when the breathing pattern meets a predetermined pattern (a breathing pattern during general snoring), the determination unit 130 may determine that the sleeper is snoring.

Thus, the detection unit 120 may detect a capacitance of the capacitor 110 and may analyze the capacitance together with the breathing pattern of the sleeper. The determination unit 130 may determine that the sleeper is snoring only when both of the two results are determined as snoring to prevent snoring from being incorrectly determined due to a snore of a person next to the sleeper when two or more peoples are during sleep.

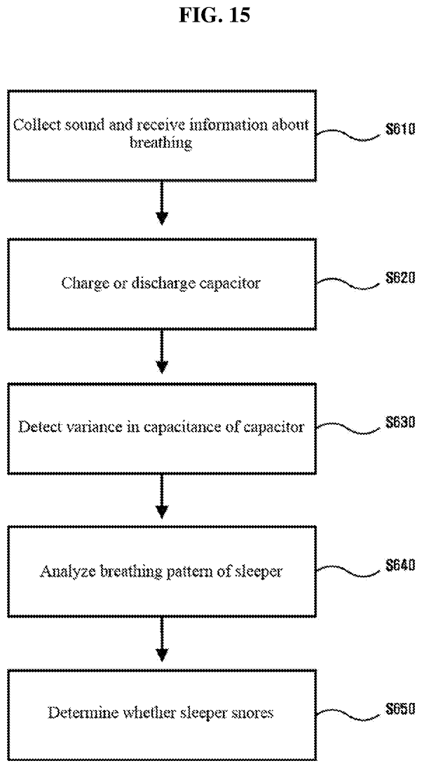

FIG. 15 is a flowchart illustrating a method for determining sleeper's snoring by means of a snore and a breathing pattern according to an embodiment of the inventive concept.

A description will be given of an example of determining sleeper's snoring by means of a snore and a breathing pattern according to an embodiment of the inventive concept with reference to FIG. 15.

First of all, in operation S610, a sound generated from a sleeper may be collected, and information about breathing of the sleeper may be received.

In detail, the information about the breathing of the sleeper may be collected via an atmospheric pressure sensor and the collected information may be transmitted to a computer.

In operation 620, a capacitor 110 of FIG. 1 may be charged or discharged by the sound collected in operation S610.

This means that, as the capacitor 110 is charged or discharged by the sound collected from the sleeper, its capacitance is changed.

In operation S630, a variance in the capacitance of the capacitor 110 may be detected.

In operation S640, a detection unit 120 of the computer may analyze a breathing pattern of the sleeper using the information about the breathing.

In detail, the detection unit 120 may analyze inspiration of the sleeper, outbreathing of the sleeper, and a level of breathing using the information about the breathing of the sleeper.

In operation S650, when the result of detecting the variance in the capacitance and the result of analyzing the breathing pattern are determined as snoring, a determination unit 130 of the computer may determine that the sleeper is snoring.

Due to this, the determination unit 130 may determine that the sleeper does not snore when only one of the two conditions is met to prevent snoring from being incorrectly determined due to another sleeper next to the sleeper or an outside sound.

The above-mentioned method for detecting the snoring according to an embodiment of the inventive concept may be combined with a server which is hardware and may be stored in a medium to be implemented as a program (or application) to be executed.

For the computer to read the program and execute the methods implemented with the program, the above-mentioned program may include a code coded into a computer language such as C, C++, Java, or a machine language readable through a device interface of the computer by a processor (CPU) of the computer. Such a code may include a functional code associated with a function and the like defining functions necessary for executing the methods and may include a control code associated with an execution procedure necessary for the processor of the computer to execute the functions according to a procedure. Further, such a code may further include a code associated with memory reference about whether additional information or media necessary for the processor of the computer to execute the functions is referred at any location (address number) of an internal or external memory of the computer. Further, if it is necessary for the processor of the computer to communicate with any computer or server located in a remote place to execute the functions, the code may further include a communication related code about how communication is performed with any computer or server located in a remote place using a communication module of the computer and whether to transmit and receive any information or media upon communication.

The medium may refer to a device-readable medium which stores data on a semipermanent basis rather than a medium, such as a register, a cache, or a memory, which stores data during a short moment. The medium may refer to a device-readable medium which stores data on a semipermanent basis rather than a medium, such as a register, a cache, or a memory, which stores data during a short moment. In other words, the program may be stored in various storage media on various servers accessible by the computer or various storage media on the computer of the user. Further, the medium may be distributed to a computer system connected over a network and may store a computer-readable code on a distributed basis.

Operations of the method or algorithm described in connection with an embodiment of the inventive concept may be directly implemented in hardware, may be implemented with a software module executed by hardware, or may be implemented by a combination of the hardware and the software module. The software module may reside on a random access memory (RAM), a read only memory (ROM), an erasable programmable ROM (EPROM), an electrically erasable programmable ROM (EEPROM), a flash memory, a hard disc, a removable disc, a CD-ROM, or any type of computer-readable storage medium which is well known in the technical field to which the inventive concept pertains.

According to an embodiment of the inventive concept, the system may detect a variance in the capacitance of a capacitor charged or discharged by a sound of a sleeper and may determine whether the sleeper snores, thus determining that a sound, which is not snoring, an outside sound, or the like is not a snore.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for detecting snoring, the method comprising:
charging or discharging a capacitor using a sound collected from a sleeper;
detecting, by a computer, a variance in capacitance of the capacitor; and
determining, by the computer, whether the sleeper snores depending on the determined result.

2. The method of claim 1, further comprising:
receiving, by the computer, information about breathing of the sleeper, the information being collected from the sleeper; and
analyzing, by the computer, a breathing pattern of the sleeper using the information about the breathing,
wherein the determining includes:
determining, by the computer, that the sleeper is snoring, when the result of detecting the variance in the capacitance and the result of analyzing the breathing pattern are determined as snoring.

3. The method of claim 1, wherein the detecting includes:
calculating an increment in capacitance per unit time; and
determining whether the increment is indicated as being greater than or equal to a first reference value at a predetermined period.

4. The method of claim 1, wherein the detecting includes:
calculating an increment in the capacitance per unit time;
calculating a second reference value using increments in the capacitance during a predetermined time; and
determining whether the increment is indicated as being greater than or equal to the second reference value at a predetermined period.

5. The method of claim 4, wherein the second reference device is calculated by multiplying a value obtained by dividing the sum of the increments during the predetermined time by an increased number of times by a constant.

6. The method of claim 3, wherein the detecting includes:
calculating the increment in capacitance per unit time; and
calculating the increment as “0”, when the increment is less than or equal to “0”.

7. The method of claim 4, wherein the detecting includes:
calculating the increment in capacitance per unit time; and
calculating the increment as “0”, when the increment is less than or equal to “0”.

8. The method of claim 1, further comprising:
increasing the volume of air in two air pockets of a pillow, when it is determined that the sleeper is snoring; and
decreasing the volume of air in the two air pockets of the pillow, when it is determined that the snoring of the sleeper is ended.

9. The method of claim 8, wherein the detecting includes:
calculating an increment in the capacitance per unit time; and
detecting whether the increment is indicated as being greater than or equal to a third reference value at a predetermined period, and
wherein the increasing of the volume of air includes:
increasing the volume of air in any one of the two air pockets and decreasing the volume of air in the other of the two air pockets.

10. The method of claim 9, wherein the increasing of the volume of air includes:
alternately increasing or decreasing the volume of air in the two air pockets at a predetermined time interval.

11. The method of claim 1, further comprising:
transmitting a time when the sleeper starts to snore and a time when the sleeper finishes snoring to a terminal of the sleeper.

12. A system for detecting snoring, the system comprising:
a collection unit configured to collect a sound;
a capacitor configured to be charged or discharged by the sound collected by the collection unit;
a detection unit configured to detect a variance in capacitance of the capacitor; and
a determination unit configured to determine whether a sleeper snores as a result of the detection of the detection unit.

13. The system of claim 12, further comprising:
an atmospheric pressure sensor configured to collect breathing information of the sleeper,
wherein the detection unit analyzes a breathing pattern of the sleeper using the collected breathing information, and
wherein the determination unit determines that the sleeper is snoring, when the result of detecting the variance in the capacitance and the result of analyzing the breathing pattern are determined as snoring.

14. The system of claim 12, wherein the detection unit calculates an increment in the capacitance per unit time, calculates a second reference value using increments in the capacitance during a predetermined time, and determines whether the increment is indicated as being greater than or equal to a first reference value or the second reference value at a predetermined period.

15. A program for detecting snoring, the program being combined with a computer which is hardware and being stored in a medium to execute the method of claim 1.
